(19) United States
(12) Patent Application Publication
(10) Pub. No.: US 2017/0138510 A1
(43) Pub. Date: May 18, 2017

(54) HANGER-TYPE VIBRATION ISOLATING DEVICE

(71) Applicants: DONG YONG KIM, CHONJU-SI (KR); IN YOL YI, GWANGJU-SI (KR); SOLOMON K. KIM, COTO DE CAZA, CA (US)

(72) Inventors: DONG YONG KIM, CHONJU-SI (KR); IN YOL YI, GWANGJU-SI (KR); SOLOMON K. KIM, COTO DE CAZA, CA (US)

(21) Appl. No.: 14/942,957

(22) Filed: Nov. 16, 2015

(51) Int. Cl. F16L 3/205; F16L 3/133; F16L 55/02; F16M 13/02

(52) U.S. Cl. CPC F16L 3/205; F16M 13/027; F16L 3/133; F16L 55/02

(57) ABSTRACT

A hanger-type vibration isolating device configured to both prevent vibration and impact applied through a building from the exterior. The vibration generated from a fluid flowing inside of a supporting object, such as a pipe. The hanger vibration isolating device includes a support rod unit fixed to a supporting object and extended in a vertical direction extended. A first vibration isolating unit is installed at the support rod unit and a second vibration isolating unit is installed at a bottom of the first vibration isolating unit that performs a vibration isolating function due to an elastical change in a vertical direction from vibration applied from the exterior. A support body is combined to a supporting object which is installed or floated through the support rod unit and movably installed between the first and second vibration isolating units.

### BACKGROUND OF THE INVENTION

Technical Field

The present invention relates to a hanger-type vibration isolating device, and more particularly, to a hanger-type vibration isolating device capable of attenuating vibration or impact to be transferred from an exterior or an object to be supported.

Description of the Related Art

In general, large buildings and apartments are provided with pipes for electric wires and/or high temperature and high pressure fluids. These pipes are installed and supported by anchor bolts fixed to a ceiling, or brackets and/or trays connected to lower ends of the anchor bolts.

However, the bracket and tray may damage the pipes due to the impact or vibration transferred from the fluids flowing in the pipes and the exterior through the building, or the anchor bolts may be broken by fatigue loads. Such damages generate danger of an accident such as a water leakage, an earth leakage, an explosion and fire, and thus a vibration isolating device is required to prevent such damages.

Korea Unexamined Patent Publication No. 10-2010-0022881 discloses a quake-resistant and vibration isolating pipe hanger.

The disclosed invention may buffer the impact applied from a building to a pipe band, but has a problem of not buffering the vibration or impact generated from the pipe band itself and attenuating the transmission to a building.

### SUMMARY OF THE INVENTION

The present invention has been created to improve the above-described problems, and an abject of the present invention is to provide a hanger-type vibration isolating device capable of attenuating vibration generated from an object to be supported, like a pipe, as well as vibration applied from the building.

To achieve the above objective, the hanger-type vibration isolating device according to the present invention includes; a support rod unit fixed to a fixing object and in a vertical direction extended; a first vibration isolating unit that does vibration isolating function due to being installed at the support rod unit, and elastically change in the vertical direction by vibration applied from the exterior; a second vibration isolating unit that does vibration isolating function due to being installed at bottom of the first vibration isolating unit, and elastically change in the vertical direction by a vibration applied from the exterior; a support body that is combined to a support object capable of being hung or floated through the support rod unit and movably installed between the first and second vibration isolating units.

According to one aspect of the present invention, the support rod unit includes an anchor bolt that one end is combined to the object, extended in a downward direction therefrom and screw is formed at outer circumferential surface of the anchor bolt; the support body includes a contact plate that is inserted through the anchor bolt and capable of in a vertical direction moving along the anchor bolt; the first vibration isolating unit includes a first vibration damping member that is inserted through the anchor bolt, installed at the upper contact plate of the support body, movably installed along the anchor bolt and attenuates a vibration applied from the exterior; and a first shock-absorbing spring that is installed to cover the anchor bolt and buffers a vibration applied from the exterior; the second vibration isolating includes a second vibration damping member that is inserted through the anchor bolt from the bottom contact plate of the support body and attenuates a vibration applied from the exterior; a second shock-absorbing spring that is installed to cover the anchor bolt and buffers a vibration applied from the exterior; and a first stopper that is combined to the anchor bolt prevents escape of the second shock-absorbing spring from lower part on the second shock-absorbing spring.

In addition, The support body includes a plurality of a lower side plates extended in a downward direction to accommodate the second vibration isolating unit from both ends of the contact plate; and a plurality of a first support plate extended in downward direction from lower part; and a bracket being combined by each combining members of the first support plates.

In accordance with another aspect of the invention, the support body includes a plurality of upper side plates that is extended from an edge of the contact plate so that the support body may accommodates the first vibration isolating unit; and a top plate that connects a top of the upper side plates each other and has a first through-hole capable of inputting and outputting the second stopper.

A hanger-type vibration isolating device according to the present invention provides the advantages that the hanger-type vibration isolating device may attenuate a vibration and an impact generated from a supporting object like a pipe installed at a support body as well as a vibration and an impact applied from building.

### BRIEF DESCRIPTION OF THE DRAWINGS

FIG. 1 is a perspective view illustrating a hanger-type vibration isolating device according to the first embodiment of the present invention.

FIG. 2 is a cross-sectional view illustrating an installed state of the hanger-type vibration isolating device in FIG. 1.

FIG. 3 is a cross-sectional view illustrating a hanger-type vibration isolating device according to the second embodiment of the present invention.

FIG. 4 is a cross-sectional view illustrating a hanger-type vibration isolating device according to the third embodiment of the present invention.

FIG. 5 is a cross-sectional view illustrating a hanger-type vibration isolating device according to the fourth embodiment of the present invention.

FIG. 6 is a cross-sectional view illustrating a hanger-type vibration isolating device according to the fifth embodiment of the present invention.

FIG. 7 is a cross-sectional view illustrating a hanger-type vibration isolating device according to the sixth embodiment of the present invention.

FIG. 8 is a cross-sectional view illustrating a hanger-type vibration isolating device according to the seventh embodiment of the present invention.

### DESCRIPTION OF SYMBOLS

110: a support rod unit
120: a first vibration isolating unit
130: a second vibration isolating unit
150: a support body

### DETAILED DESCRIPTION OF THE PREFERRED EMBODIMENT

Hereinafter, a hanger-type vibration isolating device according to preferred embodiments of the present invention will be described in detail with reference to the accompanying drawings.

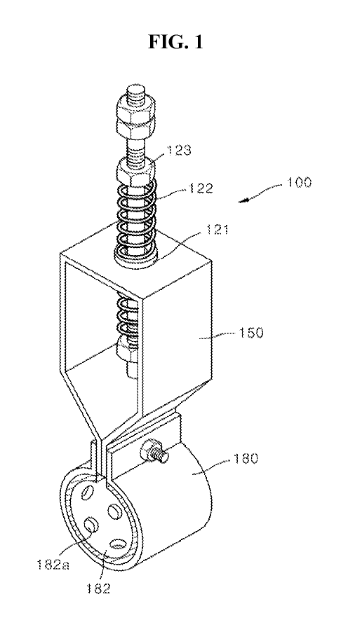

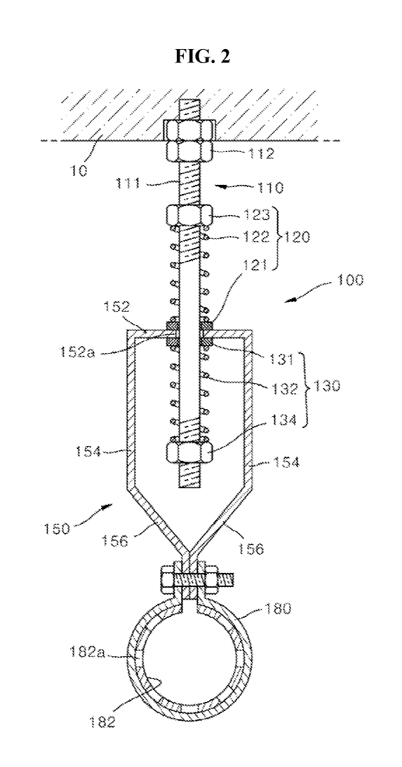

FIG. 1 is a perspective view showing a hanger-type vibration isolating device according to the first embodiment of the present invention and FIG. 2 is a cross-sectional view of an installation of a hanger-type vibration isolating device of FIG. 1.

Referring to FIG. 1 and FIG. 2, a hanger-type vibration isolating device 100 according to the first embodiment of the present invention includes a support rod unit 110, a first vibration isolating unit 120, a second vibration isolating unit 130, a support body 150.

The support rod unit 110 includes an anchor bolt 111, of which one end thereof is embedded into an object to be fixed, for example, a ceiling 10, and the other end is downwardly extended in a vertical direction and is formed with a threaded portion on an outer peripheral surface thereof, and a fixing nut 112 which is connected to the anchor bolt 111 at a position close to the ceiling in order to increase a fixing force of the anchor bolt 111 against the ceiling.

A first vibration isolating unit 120 is installed to an anchor bolt 111 applied to the support rod unit 110, is elastically deformed in a vertical direction by vibration applied from the exterior to perform a vibration isolating function.

A first vibration isolating unit 120 includes a first disc-shaped damping member 121 which is installed to an upper portion of a contact plate 152 of a support body 150 to damp the vibration applied from the exterior, the anchor bolt 111 being inserted through the first vibration damping member 121 in such a way that the first vibration damping member is movable along the anchor bolt 111; and a first shock-absorbing spring 122 of a coil spring type is installed at upper end of the first damping member 121 to cover the anchor bolt 111 and to damp the vibration applied from the exterior.

The first damping member 121 is made of the vibration isolating material known in the art, such as rubber capable of damping the vibration through elastic deformation thereof

The second vibration isolating unit 130 installed at a lower end of the first vibration isolating unit 120, is elastically deformed in the vertical direction by vibration applied from the exterior and has a vibration isolating function.

The second vibration isolating unit 130 includes a second disk-shaped damping member 131 which is formed with a through-hole and installed to a lower portion of a contact plate 152 of a support body 150 to damp vibration applied from the exterior. The anchor bolt 111 is inserted through the second vibration damping member 131. A second shock-absorbing spring 132 of a coil type is installed at a lower portion of the anchor bolt 111, below the second vibration damping member 131 to cover the anchor bolt 111 and to damp the vibration applied from the exterior. A first nut 134 is connected to the anchor bolt 111 at a lower portion of a second shock-absorbing spring 132 to prevent the second shock-absorbing spring 132 from being released.

The first nut 134 is an example of a first stopper, and the first nut 134 may be substituted by a common bolt head which is formed integrally with the anchor bolt 111 and has an enlarged outer diameter.

The second damping member 131 is made of the vibration isolating material known in the art, such as rubber capable of damping the vibration through elastic deformation thereof, like the first damping member 121.

Reference numeral 123 indicates a second nut connected to the anchor bolt 111 so as to limit an upward movement range of the shock-absorbing spring 122 as an example of the second stopper.

Alternatively, a disc-shaped metal plate (not illustrated) may be sandwiched between the first damping member 121 and the first shock-absorbing spring 122 and between the second damping member 131 and the second shock-absorbing spring 132 in order to suppress deformation of the first damping member 121 and the second damping member 131 and distribute the transferred vibration and impact to all of the first damping member 121 and the second damping member 131.

The support body 150 is connected to an object to be supported which is suspended or freely moved by the support rod unit 110, for example, a pipe or a tray, and is movably installed between the first vibration isolating unit 120 and the second vibration isolating unit 130.

The support body 150 includes the contact plate 152 which is inserted through the anchor bolt 111 in such a way that the contact plate 152 is movable along the anchor bolt 111 in a vertical direction between the first damping member 121 and the second damping member 131. A plurality of lower side plates 154 extend from both ends of the contact plate 152 in a downward direction to receive the second vibration isolating unit 130 therein. A plurality of a first support plate 156 extend from lower portions of the lower side plates 154 in a downward direction, and have distal ends which are close to each other. A band type bracket 180 is connected to the first support plates 156 by coupling member like a bolt and nut located in a portion close to the first support plates 156 to receive the object to be supported therein.

A contact plate 152 has a hole 152a through which the anchor bolt 111 penetrates.

The inner surface of the bracket 180 is provided with a vibration isolating pad 182 of a sheet type which is attached to the inner surface of the bracket.

The vibration isolating pad 182 is made of a rubber material capable of providing a vibration damping effect.

In addition, the vibration isolating pad 182 is preferably formed with a plurality of through-holes 182a formed to be spaced from each other.

With the configuration of the vibration isolating device 100, when the object to be supported, i.e., the pipe (not illustrated), is connected to the bracket 180, the vibration generated from a fluid flowing in the pipe is primarily attenuated by the vibration isolating pad 182. The vibration applied through the support body 150 is attenuated in the vertical direction by the first vibration isolating unit 120 and the second vibration isolating unit 130 on the basis of the support body 150, and thus is hardly transferred to the ceiling 10 through the anchor bolt 111.

In addition, the vibration transferred from the ceiling 10 through the anchor bolt 111 is also damped by the first vibration isolating unit 120 and the second vibration isolating unit 130.

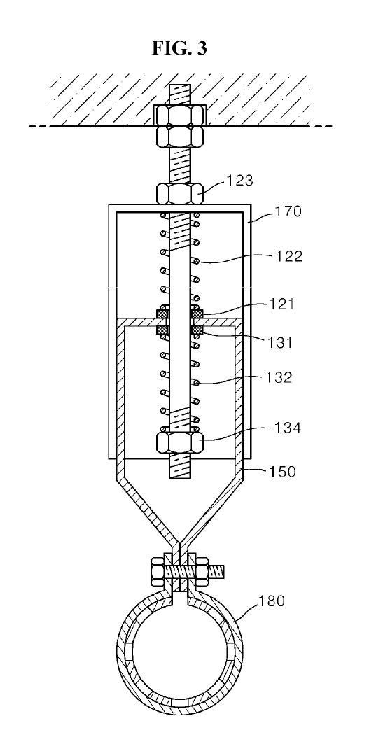

Alternatively, an external housing 170 may be provided which is sandwiched between the second nut 123 and the upper end of the first shock-absorbing spring 122 to surround the first vibration isolating unit 120 and a portion of the support body 150, as illustrated in FIG. 3.

Also, the external housing 170 may be provided to cover the support body 150 in a direction of 90 degrees with respect to the support body 150, in order to close the open side of the support body 150.

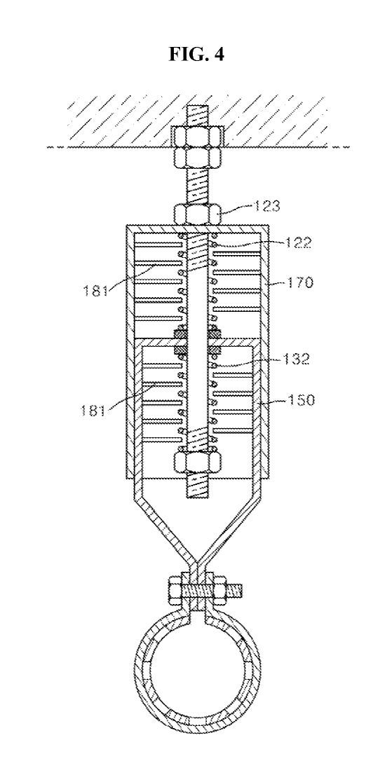

In addition, in order to further increase the damping force, as illustrated in FIG. 4, a plurality of vibration isolating sheets 181 may be provided between the first shock-absorbing spring 122 and the second shock-absorbing spring 132, and are extended in a horizontal direction from the inner walls of the external housing 170 and the support body 150.

The vibration isolating sheet 181 is made of a rubber material, for example.

In this case, the vibration energy is further damped by contraction of the first shock-absorbing spring 122 and the second shock-absorbing spring 132 when the first shock-absorbing spring 122 and the second shock-absorbing spring 132 are brought into contact with the vibration isolating sheet 181.

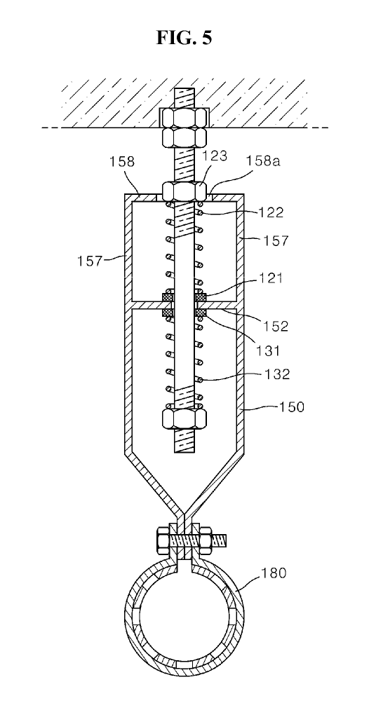

Alternatively, the support body 150 may be applied, as illustrated in FIG. 5. The components having the same functions are indicated by the same reference numerals.

Referring to FIG. 5, the support body 150 further includes a plurality of a top side plates 157 extending from an edge of the contact plate 152 in an upward direction to receive the first vibration isolating unit 120. A top plate 158 connects upper ends of the top side plates 157 and is formed with a first through-hole 158a through which a second nut 123 moves.

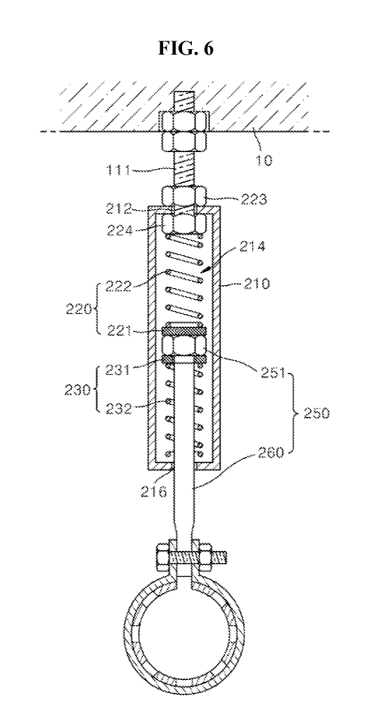

The vibration isolating device according to another embodiment of the present invention is described with reference to FIG. 6.

Referring to FIG. 6, a support rod unit of the vibration isolating device 200 includes the anchor bolt 111 connected to the object to be fixed at one end thereof embedded to the ceiling 10. The anchor bolt 111 extends in a downward direction, and is formed with a threaded portion on an outer peripheral surface thereof. A support housing 210 is formed with a second through-hole 212 in the top surface thereof, through which the anchor bolt 111 is inserted, has an inner storage space 214, and is formed with a third through-hole 216 in the bottom surface thereof. A third nut 223 is connected to the anchor bolt 111 on the support housing 210 to restrict its movement above the support housing 210. A fourth nut 224 is connected to the anchor bolt 111 on its lower portion to fix the support housing 210 to the anchor bolt 111.

The third nut 223 is one example of the third stopper, the fourth nut 224 is one example of the fourth stopper.

With the above configuration, the first vibration isolating unit 220 includes a first shock-absorbing spring 222 which is installed in series to a lower end of the fourth nut 224 in the internal storage space 214 of the support housing 210 to buffer the vibration applied from the exterior. A first vibration damping member 221 is installed to a lower portion of the first shock-absorbing spring 222 to damp vibration applied from the exterior.

Here, the first vibration damping member 221 is applied as a disk shape.

The second vibration isolating unit 230 includes a second vibration damping member 231 which is installed near the lower end of the first damping member 221 such that the second vibration damping member 231 is spaced apart from the lower end, to buffer the vibration applied from the exterior. A second shock-absorbing spring 232 is installed between a lower end of the second damping member 231 and a bottom surface of the support housing 210 to buffer the vibration applied from the exterior.

In addition, the support body 250 includes a contact member 251 which is installed between the first damping member 221 and the second damping member 231 to be movable in a vertical direction. A lower support rod 260, which penetrates the second damping member 231 and the second shock-absorbing spring 232 from the contact member 251, extends to an outside of the support housing 210 through the third through-hole 216. The lower support rod 260 is formed to be combined with a bracket 180 which is formed to the object to be supported. The bracket 180 is fixed to a lower end of the support body 250.

A part capable of combining with the bracket 180 of the lower support rod 260 is formed as plate type to provide sufficient area of contact.

In addition, in the shown example, the contact member 251 includes a nut combined with a screw thread provided at the upper end of the lower support rod 260, but can differ from the example shown. The contact member 251 includes a structure that is integrally attached and that outer diameter thereof is formed larger than the bottom support rod 260.

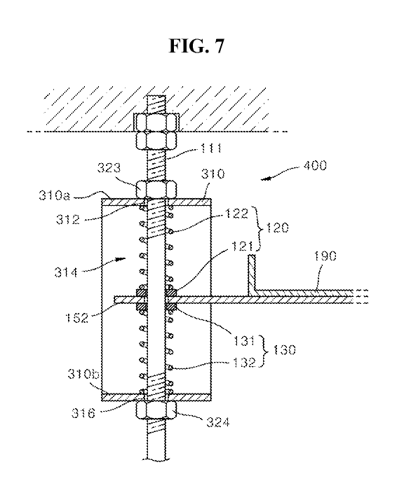

FIG. 7 shows a vibration isolating device according to another embodiment of the present invention. The element having the same function are denoted by the same reference numerals.

Referring to FIG. 7, a support rod unit includes the anchor bolt 111 with one end thereof embedded to the ceiling 10, a fixing object. The anchor bolt 111 extends in a downward direction and formed to screw at external peripheral surface. A support housing 310 has a second through-hole 312 inserted in the anchor bolt 111 located the top surface 310a thereof. The support housing 310 has an internal storage space 314 with open side surface and has a third through-hole 316 at a bottom surface thereof. A third nut 323 attaches to the anchor bolt 111 at the top of the support housing 310 to restrict movement in an upward direction of the support housing 310. A fourth nut 324 attached to the anchor bolt 111 at a bottom surface 310b outside of the support housing 310 to fix the support housing 310 to the anchor bolt 111.

With the above configuration, the first vibration isolating unit 120 and second vibration isolating unit 130 are inserted through the anchor bolt 111 and only the contact plate 152, applied as a support body 150, between the first vibration isolating unit 120 and the second vibration isolating unit 130 is installed along a side surface of the support housing 310.

A C-shaped tray 190 is connected to the contact plate 152 in order to secure the object to be support, such as an electric wire, instead of the band-shaped bracket 180.

In this case, the vibration isolating devices are provided to both sides of the tray 190, and only one is shown in this embodiment, for the clarity of the drawings.

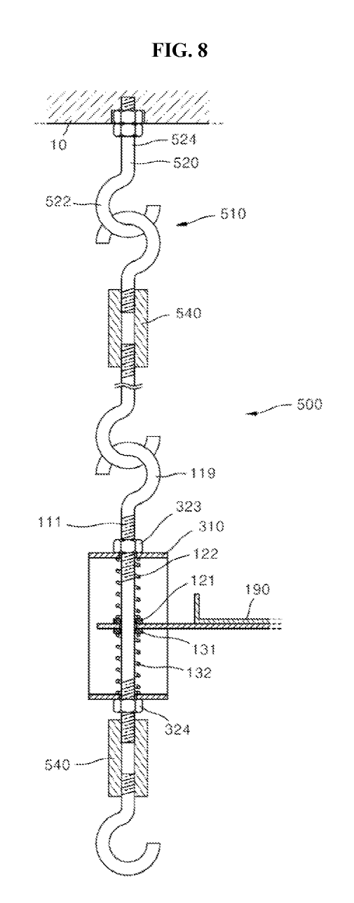

Moreover, as shown in FIG. 8, a hook linking structure may be provided to allow the support body to move and rotate on a horizontal plane. The same components are designated by the same reference numerals.

Referring to FIG. 8, the support rod unit 510 of a vibration isolating device 500 is connected to the object to be fixed, for example, the ceiling 10, and has a hook member 520 with a first arc-shaped hook portion 522 at a lower end thereof. The anchor bolt 111 has a second arc-shaped hook portion 119 which is seated on the first hook portion 522 and is supported to be rotated on the horizontal plane.

The hook member 520 is formed with a threaded portion which extends from an end of a shank 524 to a predetermined length in the vertical direction.

One or more hook members 520 are connected to the anchor bolt 111 extended to the lower portion of the support housing 310 by a coupler 540, as illustrated in FIG. 8.

The coupler 540 is formed with a female threaded portion therein.

In addition, the vibration isolating device 500 may be installed in a multiple stage by use of the anchor bolt 111 extending to the lower portion of the support housing 310 and the coupler 540.

Although the vibration isolating device 500 is shown to configured to be suspended from the ceiling 10, it may be installed to the ground in a standing state.

With the vibration isolating device described above, the present invention provides the advantage of damping the vibration generated from the object to be supported, such as a pipe, an electric wire, installed to the support body, as well as the vibration applied from the building.

1. A hanger-type vibration isolating device, comprising:
a support rod unit fixed to an object to be fixed and extended in a vertical direction, the support rod unit comprises an anchor bolt connected to the object to be fixed at one end thereof, the support rod unit is extended in a downward direction and formed with a threaded portion on an outer peripheral surface thereof;
a first vibration isolating unit installed to the support rod unit and elastically deformable in the vertical direction by a vibration applied from an exterior to isolate the vibration;
a second vibration isolating unit installed to a lower portion of the first vibration isolating unit and elastically deformable in the vertical direction by the vibration applied from the exterior to isolate the vibration;
a support body connected to an object to be supported and movably installed between the first and second vibration isolating units, the object to be supported is suspendable or freely moveable by the support rod unit, the support body comprises: a contact plate inserted through the anchor bolt such that the contact plate is movable along the anchor bolt in the vertical direction; a plurality of lower side plates which are extended from both ends of the contact plate in the downward direction to receive the second vibration isolating unit therein; a plurality of first support plates which are extended from lower portions of the lower side plates in the downward direction and the first support plates have distal ends which are close to each other, and a bracket connected to the first support plates by a combining member to receive the object to be support therein;
wherein the first vibration isolating unit comprises: a first vibration damping member installed to an upper portion of the contact plate of the support body to damp the vibration applied from the exterior, the anchor bolt is inserted through the first vibration damping member such that the first vibration damping member is movable along the anchor bolt; a first shock-absorbing spring installed to an upper portion of the first vibration damping member to cover the anchor bolt and to damp the vibration applied from the exterior; and a second stopper installed to an upper portion thereof to prevent the first shock-absorbing spring from being released;
wherein the second vibration isolating unit comprises: a second vibration damping member installed to a lower portion of the contact plate of the support body to damp the vibration applied from the exterior, the anchor bolt is inserted through the second vibration damping member such that the second vibration damping member is movable along the anchor bolt; a second shock-absorbing spring installed to a lower portion of the second vibration damping member to cover the anchor bolt and to damp the vibration applied from the exterior; and a first stopper connected to the anchor bolt at a lower portion of the second shock-absorbing spring to prevent the second shock-absorbing from being released.

2. The hanger-type vibration isolating device of claim 1, wherein the bracket comprises a vibration isolating pad on an inner surface thereof; and wherein the support body comprises a plurality of vibration isolating sheets configured to move in a gap formed between the first and second shock-absorbing springs, and the vibration isolating sheets are made of a vibration isolating material.

3. The hanger-type vibration isolating device of claim 1, wherein the support body further comprises a plurality of top side plates extending from an edge of the contact plate in an upward direction to receive the first shock-absorbing unit therein; a top plate connecting upper ends of the top side plates and formed with a through-hole;
and a nut moveable through the through-hole.

4. A hanger-type vibration isolating device comprising:
a support rod unit fixed to an object to be fixed and extended in a vertical direction, the support rod unit comprises: an anchor bolt connected to the object to be fixed at one end thereof, the support rod unit is extended in a downward direction and formed with a threaded portion on an outer peripheral surface thereof; a support housing formed with a first through-hole, the anchor bolt is insertable through the first through-hole, the support housing comprises an inner receiving space and a second through-hole in a bottom surface thereof; a first stopper connected to the anchor bolt on the support housing to restrict the support housing from moving in an upward direction; and a second stopper connected to the anchor bolt below a top surface of the support housing to fix the support housing to the anchor bolt;
a first vibration isolating unit installed to the support rod unit and elastically deformable in the vertical direction by a vibration applied from an exterior to isolate the vibration, the first vibration isolating unit comprises: first shock-absorbing spring installed to a lower portion of the second stopper in the inner receiving space of the support housing to buffer the vibration applied from the exterior; and a first vibration damping member installed to a lower portion of the first shock-absorbing spring such that the first vibration damping member is spaced apart from the lower portion and is configured to buffer the vibration applied from the exterior;
a second vibration isolating unit installed to a lower portion of the first vibration isolating unit and elastically deformable in the vertical direction by the vibration applied from the exterior to isolate the vibration, the second vibration isolating unit comprises: a second vibration damping member installed to a lower portion of the first damping member such that the second vibration damping member is spaced apart from the lower portion and is configured to buffer the vibration applied from the exterior; and a second shock-absorbing spring installed between a lower portion of the second damping member and a bottom surface of the support housing to buffer the vibration applied from the exterior; and
a support body connected to an object to be supported and movably installed between the first and second vibration isolating units, the object to be supported is suspendable or freely moveable by the support rod unit and is fixed to a lower end of the support body, the support body comprises: a contact member installed between the first and second damping members and moveable in the vertical direction; and a lower support rod penetrating the second damping member and the second shock-absorbing spring and extending to outside of the support housing through the second through-hole.

5. A hanger-type vibration isolating device comprising:
a support rod unit fixed to an object to be fixed and extended in a vertical direction, the support rod unit comprises: an anchor bolt connected to the object to be fixed at one end thereof, the support rod unit is extended in a downward direction and formed with a threaded portion on an outer peripheral surface thereof; a first hook member connected to the object to be fixed and comprising a first arc-shaped hook portion; and a second hook member comprising a second arc-shaped hook portion seated on the first hook portion at an upper end of the anchor bolt such that the second hook member is configured to be rotatable on a horizontal plane;
a first vibration isolating unit installed to the support rod unit and elastically deformable in the vertical direction by a vibration applied from an exterior to isolate the vibration;
a second vibration isolating unit installed to a lower portion of the first vibration isolating unit and elastically deformable in the vertical direction by the vibration applied from the exterior to isolate the vibration;
a support body connected to an object to be supported and movably installed between the first and second vibration isolating units, the object to be supported is suspendable or freely moveable by the support rod unit, the support body comprises: a contact plate inserted through the anchor bolt such that the contact plate is movable along the anchor bolt in the vertical direction;
wherein the first vibration isolating unit comprises: a first vibration damping member installed to an upper portion of the contact plate of the support body to damp the vibration applied from the exterior, the anchor bolt is inserted through the first vibration damping member such that the first vibration damping member is movable along the anchor bolt; and a first shock-absorbing spring installed to an upper portion of the first vibration damping member to cover the anchor bolt and to damp the vibration applied from the exterior; and
wherein the second vibration isolating unit comprises: a second vibration damping member installed to a lower portion of the contact plate of the support body to damp the vibration applied from the exterior, the anchor bolt is inserted through the second vibration damping member; a second shock-absorbing spring installed to a lower portion of the second vibration damping member to cover the anchor bolt and to damp the vibration applied from the exterior; and a first stopper connected to the anchor bolt at a lower portion of the second shock-absorbing spring to prevent the second shock-absorbing from being released.
